(19) United States
(12) Patent Application Publication
(10) Pub. No.: US 2026/0303987 A1
(43) Pub. Date: Oct. 1, 2026

(54) SENSING METHOD, CONSTRUCTION METHOD FOR OPTOELECTRONIC SENSING SYSTEM, OPTOELECTRONIC SENSING SYSTEM, AND ELECTRONIC DEVICE

(71) Applicant: FOURIAS INC, DOVER, DE (US)

(72) Inventors: Miao JIANG, Shenzhen (CN); Fenghua LI, DOVER, DE (US)

(21) Appl. No.: 19/632,460

(22) Filed: Mar. 30, 2026

Related U.S. Application Data
(60) Provisional application No. 63/781,341, filed on Mar. 31, 2025.

(51) Int. Cl. H04N 23/955; G06V 10/82

(52) U.S. Cl. CPC H04N 23/955; G06V 10/82

(57) ABSTRACT

Provided a sensing method, a construction method for an optoelectronic sensing system, an optoelectronic sensing system, and an electronic device. The sensing method is applied to an optoelectronic sensing system deployed with an optoelectronic neural network model. The optoelectronic neural network model includes a feature screening module and a feature processing module. The optoelectronic sensing system includes an optical element and a photosensitive element. The photosensitive element is configured to collect an optical signal passing through the optical element and output an image signal, and a parameter of the optical element is determined based on a parameter of the feature screening module. The method includes: obtaining the image signal outputted by the photosensitive element; and processing the image signal through the feature processing module to output sensing information.

### CROSS-REFERENCE TO RELATED APPLICATION

This application claims the benefits of U.S. Provisional Patent Application No. 63/781,341, filed on Mar. 31, 2025, the entire disclosure of which is incorporated herein by reference.

### FIELD

The present disclosure belongs to the technical field of artificial intelligence, and in particular, relates to a sensing method, a construction method for an optoelectronic sensing system, an optoelectronic sensing system, an electronic device, a computer-readable storage medium, and a computer program product.

### BACKGROUND

At present, artificial intelligence is developing vigorously, and various artificial intelligence-based models have emerged to meet people’s diverse demands. Image-based models are particularly widely used.

However, in order to achieve a high prediction accuracy, it is generally necessary to collect an image using a high-precision camera, and then perform a series of complex processing on the image before outputting a prediction result, leading to problems such as easy privacy leakage and high computing resource consumption.

### SUMMARY

The present disclosure aims to solve at least one of the technical problems existing in the prior art. To this end, the present disclosure proposes a sensing method, a construction method for an optoelectronic sensing system, an optoelectronic sensing system, an electronic device, a computer-readable storage medium, and a computer program product, which can reduce computing resource consumption of the model. Moreover, after incident light is processed by an optical element, image data collected by a photosensitive element is no longer data of an original scene, thus avoiding privacy leakage.

In a first aspect, the present disclosure provides a sensing method. The sensing method is applied to an optoelectronic sensing system deployed with an optoelectronic neural network model. The optoelectronic neural network model includes a feature screening module and a feature processing module. The optoelectronic sensing system includes an optical element and a photosensitive element. The photosensitive element is configured to collect an optical signal passing through the optical element and output an image signal, and a parameter of the optical element is determined based on a parameter of the feature screening module. The method includes: obtaining the image signal outputted by the photosensitive element; and processing the image signal through the feature processing module to output sensing information.

In a second aspect, the present disclosure provides a construction method for an optoelectronic sensing system. The construction method includes: constructing an optoelectronic neural network model, where the optoelectronic neural network model includes a feature screening module and a feature processing module; constructing an optical element of the optoelectronic sensing system based on a parameter of the feature screening module; and deploying the feature processing module in a circuit module of the optoelectronic sensing system.

In a third aspect, the present disclosure provides an optoelectronic sensing system. The optoelectronic sensing system includes: a memory; a processor; and a computer program stored in the memory and executable on the processor. The processor, when executing the program, implements the sensing method as described above. Alternatively, the optoelectronic sensing system is constructed based on the construction method as described above.

In a fourth aspect, the present disclosure provides an electronic device. The electronic device includes the optoelectronic sensing system as described above.

In a fifth aspect, the present disclosure provides a non-transitory computer-readable storage medium. The non-transitory computer-readable storage medium has a computer program stored thereon. The computer program, when executed by a processor, implements the sensing method or the construction method as described above.

In a sixth aspect, the present disclosure provides a computer program product. The computer program product includes a computer program. The computer program, when executed by a processor, implements the sensing method or the construction method as described above.

In the sensing method, the construction method for the optoelectronic sensing system, the optoelectronic sensing system, the electronic device, the computer-readable storage medium, and the computer program product provided by the embodiments of the present disclosure, an incident light field is adjusted through the optical element, which can perform a convolution operation on an input feature similar to that in a conventional neural network, thereby implementing a function of the feature screening module in the optoelectronic neural network model. After the incident light is modulated by the optical element, emergent light propagating to the photosensitive element no longer carries unprocessed raw information of a current scene. Since the information processing occurs at a physical level, privacy leakage in the current scene is avoided.

Subsequently, the photosensitive element may collect the emergent light to output the image signal, and transmit the image signal to the feature processing module. The feature processing module may process the image signal to achieve the sensing of scene targets, such as object recognition, gesture recognition, and scene recognition.

Moreover, compared with information processing through the feature screening module, which consumes a large amount of computing resources, implementing the same information processing process through the optical element consumes no computing resources, thus reducing computing resource consumption of the optoelectronic neural network model during sensing.

In addition, since the modulation by the optical element is performed at a speed of light, implementing the function of the feature screening module through the optical element can also improve sensing efficiency of the optoelectronic neural network model.

Additional aspects and advantages of the embodiments of the present disclosure will be provided in part in the following description, or will become apparent in part from the following description, or can be learned from practicing of the embodiments of the present disclosure.

### BRIEF DESCRIPTION OF THEDRAWINGS

The above and/or additional aspects and advantages of the present disclosure will become more apparent and more understandable from the following description of embodiments taken in conjunction with the accompanying drawings, in which:

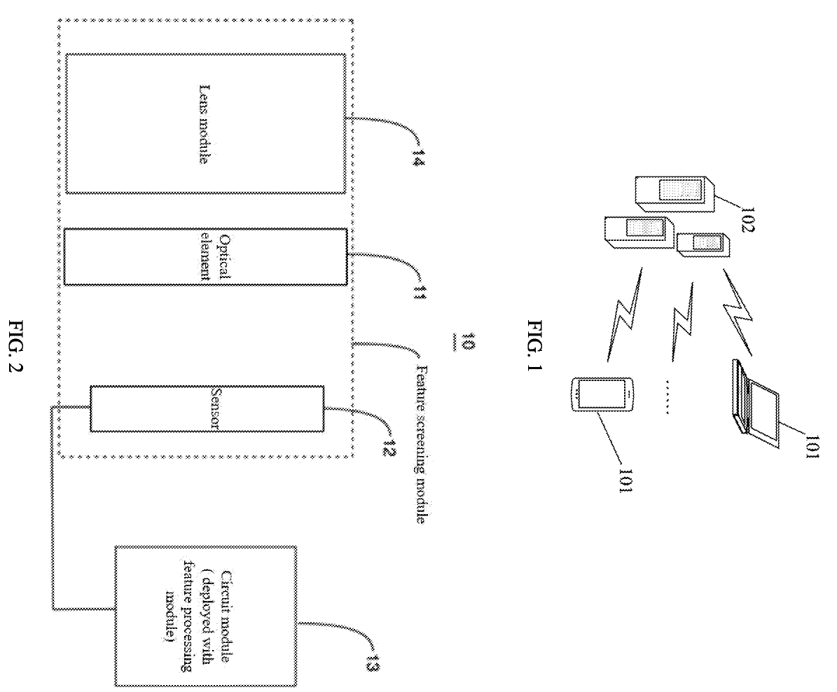

FIG. 1 is a diagram of an application scene of a sensing method provided according to an embodiment of the present disclosure.

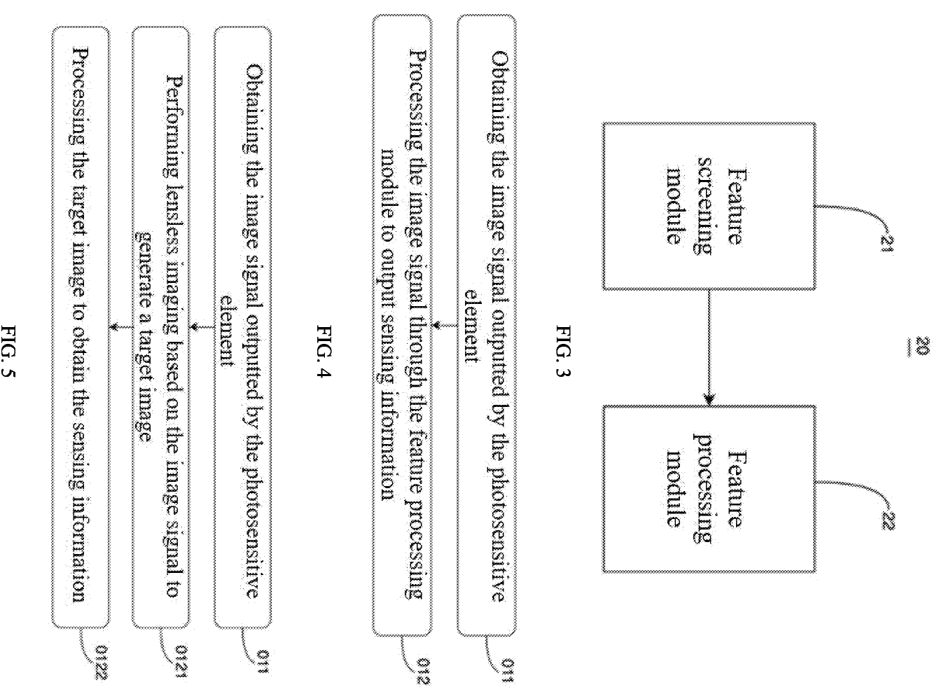

FIG. 2 is a schematic structural diagram of an optoelectronic sensing system provided according to an embodiment of the present disclosure.

FIG. 3 is a schematic block diagram of an optoelectronic neural network model provided according to an embodiment of the present disclosure.

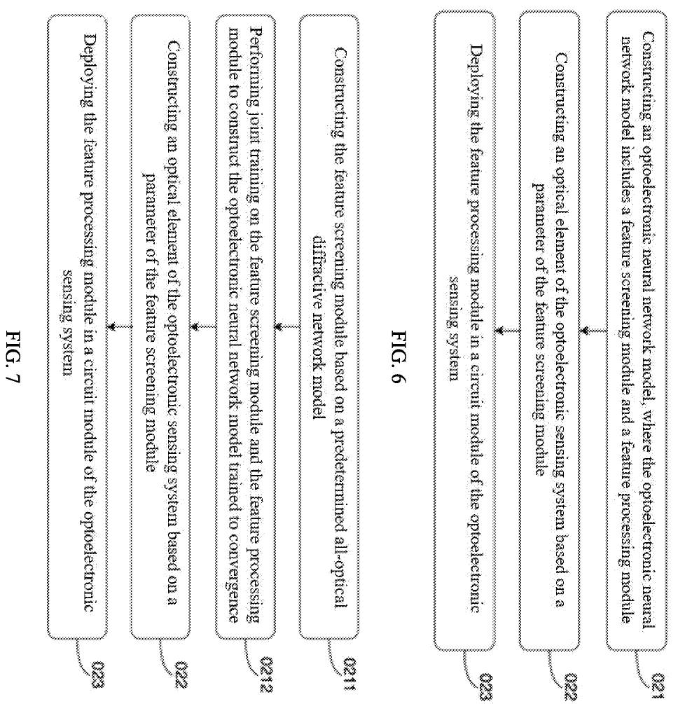

FIG. 4 is a first schematic flowchart of a sensing method provided according to an embodiment of the present disclosure.

FIG. 5 is a second schematic flowchart of a sensing method provided according to an embodiment of the present disclosure.

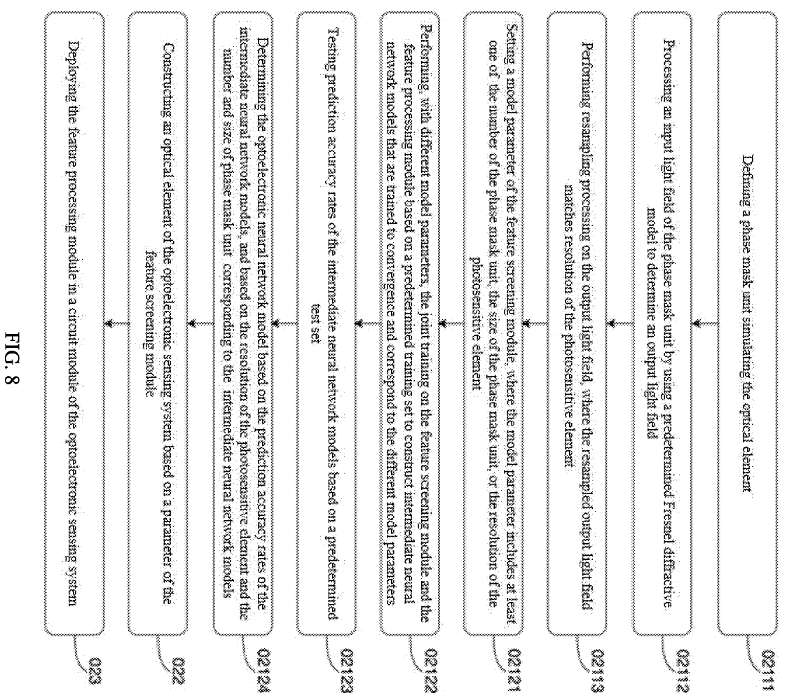

FIG. 6 is a third schematic flowchart of a sensing method provided according to an embodiment of the present disclosure.

FIG. 7 is a fourth schematic flowchart of a sensing method provided according to an embodiment of the present disclosure.

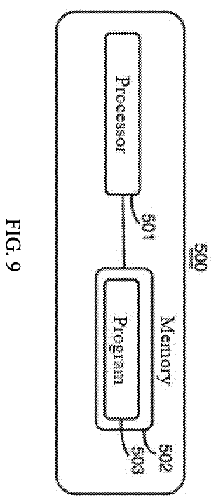

FIG. 8 is a fifth schematic flowchart of a sensing method provided according to an embodiment of the present disclosure.

FIG. 9 is a schematic structural diagram of an optoelectronic sensing system provided according to an embodiment of the present disclosure.

### DETAILED DESCRIPTION OF THE EMBODIMENTS

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

### To facilitate understanding, the technical background and application scenes of the present disclosure are introduced below.

1. Optical Neural Networks (ONN) are computational models that implement neural network functions using optical principles and technologies. Compared with traditional electronic neural networks, ONNs have unique advantages and application prospects. The ONNs are described in detail below.

### 1. Basic principle: The ONN processes information based on characteristics of light, such as propagation, interference, and diffraction. The light propagates at an extremely high speed and may be transmitted in parallel in space without mutual interference, which enables the ONN to achieve high-speed parallel computing. In the ONN, optical signals are used to represent input data, a weight, and an output result. For example, input information is encoded by modulating an intensity, phase, or frequency of a laser beam through an optical element, and the optical element is used to realize transmission, combination, and transformation of the optical signals, simulating connection and information transmission between neurons in a neural network.

### 2. Composition and structure

Input layer: Converts input data into optical signals. Typically, an electrooptical modulator is used to convert electrical signals into the optical signals, or an optical sensor is directly used to obtain the optical signals as an input.

Hidden layer: Consists of a series of optical elements and processing units for processing and transforming the optical signals. These elements may perform operations such as focusing, scattering, and interference of light, thereby simulating computing and information transmission of neurons. For example, a Spatial Light Modulator (SLM) is used to modulate an optical field, adjust a phase, amplitude, or polarization state of the light, thereby implementing operations such as weighted summation of the optical signals.

Output layer: Converts the processed optical signals into the electrical signals or other forms of output. Typically, a photodetector is used to convert the optical signals into the electrical signals for subsequent further processing and analysis.

2. Deep Neural Network (DNN) is a neural network with a plurality of hidden layers, and its basic structure is mainly composed of an input layer, a hidden layer, and an output layer. The DNN is described in detail below.

### 1. Input layer

Function: The input layer is an entry for the DNN to receive external data. It does not perform any computation, and is only responsible for transmitting raw data to the next layer. The number of neurons in the input layer is usually determined by feature dimensionality of the input data.

Example: In an image recognition task, when an input is a grayscale image of 28×28 pixels, the number of neurons in the input layer is 28×28=784, with each neuron corresponding to a pixel value in the image.

### 2. Hidden layer

Function: The hidden layer is a core part of the DNN for implementing complex function approximation and feature extraction. Neurons in the hidden layer perform non-linear transformation on the input data, converting the raw data into a higher-level and more abstract feature representation by learning patterns and features in the input data. The number of hidden layers and the number of neurons in each layer are adjustable hyperparameters. The greater the number of layers, the stronger an expression capability of the network, but the network is also more prone to an overfitting problem.

Structure: Each hidden layer is composed of a plurality of neurons, which are interconnected through weights. The neurons perform weighted summation on the input signals, and then perform the non-linear transformation through an activation function to obtain output signals. Common activation functions include a Sigmoid function, a ReLU function, a Tanh function, and the like. For example, the ReLU function can effectively solve a gradient vanishing problem and accelerating a training speed of the network.

Multi-layer hidden layers: A deep neural network usually contains a plurality of hidden layers, which is the origin of the term “deep”. The multi-layer hidden layers enable the network to progressively learn features of different levels from the data, ranging from low-level simple features (such as an edge and a texture) to high-level complex features (such as a shape and category of an object).

### 3. Output layer

Function: The output layer is responsible for converting the features learned by the hidden layers into a final prediction result. The number of neurons in the output layer and the selection of the activation function depend on a specific task.

Example: In a binary classification task, the output layer usually has only one neuron, and the Sigmoid activation function is used to map an output value to an interval [0, 1], representing a probability of belonging to the positive class. In a multi-classification task, the number of neurons in the output layer is equal to the number of categories, and the Softmax activation function is used to convert output values into a probability distribution for each category.

### 4. Inter-layer connection and weight

Fully connected: In the DNN, neurons between two adjacent layers usually adopt a fully connected manner, i.e., each neuron in an upper layer is connected to each neuron in a lower layer. Each connection has a corresponding weight, which represents a strength of the connection between two neurons. The weight is continuously adjusted through training, so that the network can learn a pattern and feature in the data.

Bias: Except for the weight, each neuron also has a bias term, which can be regarded as an additional input for adjusting an activation threshold of the neuron. The bias term allows the neuron to generate a certain output even in the absence of an input signal, thus increasing flexibility of the network.

### 5. Learning process

A learning process of the DNN mainly includes two stages of forward propagation and backpropagation.

Forward propagation: The input data starts from the input layer, passes through various hidden layers in sequence, and finally reaches the output layer, yielding a prediction result of the network. In this process, each neuron performs weighted summation based on the input signal and weight, then performs the non-linear transformation through the activation function, and transmits the result to the next layer.

Backpropagation: Based on an error between the prediction result of the network and a real label, an optimization algorithm, such as gradient descent, is used to reversely compute gradients of each weight and each bias with respect to the error starting from the output layer. Then, the weights and biases are updated based on the gradients to reduce the error. This process is iterated continuously until performance of the network reaches a satisfactory level.

The sensing method of the present disclosure uses the optical neural network to replace a portion of modules in the optoelectronic neural network model, and organically combines the optical neural network with a conventional neural network model, which can reduce computing resource consumption of the model. Moreover, after incident light is processed by the optical element, image data collected by the photosensitive element is no longer data of an original scene, thus avoiding privacy leakage.

FIG. 1 is a diagram of an application scene of a sensing method provided according to an embodiment of the present disclosure. Referring to FIG. 1, the application scene provided by the present disclosure includes an electronic device 101 and a server 102. The sensing method provided by the present disclosure may be executed by at least one of the electronic device 101 or the server 102.

The electronic device may include, but is not limited to: terminal devices (such as a mobile phone, a computer, or a watch), wearable devices (such as a pair of Augmented Reality (AR) goggles, a pair of Virtual Reality (VR) goggles, a pair of Extended Reality (XR) goggles, or a head-mounted display), security devices, smart home devices, robots, and other devices that may be equipped with the optoelectronic sensing system, which is not limited in the embodiments of the present disclosure.

The server may be an independent physical server, a server cluster or a distributed system composed of a plurality of physical servers, or a cloud server that provides basic cloud computing services such as a cloud service, a cloud database, cloud computing, a cloud function, cloud storage, a network service, cloud communication, a middleware service, a domain name service, a security service, a ContentDelivery Network (CDN), or a big data and artificial intelligence platform, which is not limited in the embodiments of the present disclosure.

It should be noted that the number of electronic devices and the number of servers in FIG. 1 are for illustration purposes only, and may be more or fewer which is not limited herein. The electronic device and the server may be connected directly or indirectly through wired or wireless communication, which is not limited in the present disclosure.

The sensing method involved in the present disclosure may be implemented relying on a cloud technology.

The cloud technology refers to a hosting technology that unifies a series of resources, such as hardware, software, and networks in a wide area network or a local area network to realize computing, storage, processing, and sharing of data.

The cloud technology is a general term for a network technology, an information technology, an integration technology, a management platform technology, an application technology, and the like based on a cloud computing business model, which can form a resource pool to achieve on-demand utilization with flexibility and convenience. A cloud computing technology will become an important support. A backend service for a technical network system requires a large amount of computing and storage resources, such as a video website, an image-based website, and more portal websites. With the in-depth development and application of the Internet industry, every object may have its own recognition mark in the future, which needs to be transmitted to a backend system for logical processing. Data of different levels is processed separately, and various types of industry data require strong backing support from a powerful system, which can only be realized through cloud computing.

The sensing method of the present disclosure may be implemented based on the cloud computing. The cloud computing is a computing pattern that distributes computing tasks across a resource pool formed by a large number of computers, enabling various application systems to obtain computing power, a storage space, and an information service as needed. A network that provides resources is referred to as the “cloud”. For a user, the resources in the “cloud” are infinitely scalable, available at any time, usable on demand, expandable in real time, and charged based on actual use.

A provider of a basic cloud computing capability establishes a cloud computing resource pool platform (referred to as a cloud platform for short, and generally called an Infrastructure as a Service (IaaS) platform), and deploys various types of virtual resources in the resource pool for an external customer to select and use. The cloud computing resource pool mainly includes: a computing device (that is a virtualized machine with an operating system), a storage device, and a network device.

The sensing method in the embodiments of the present disclosure may be executed by at least one of the electronic device or the server. That is, the method may be executed separately by the server or the electronic device, or jointly by the server and the electronic device. Therefore, an execution subject of each step is omitted below.

Referring to FIG. 2, the optoelectronic sensing system 10 in the embodiments of the present disclosure may be mounted on the electronic device. Alternatively, a portion of the optoelectronic sensing system 10 may be mounted on the electronic device, and the other portion of the optoelectronic sensing system 10 may be deployed on the server.

The optoelectronic sensing system 10 refers to a system that performs a specific sensing task by collecting an optical signal of a scene. For example, the specific sensing task includes object recognition, gesture recognition, and scene recognition in the scene.

In some embodiments, the optoelectronic sensing system 10 includes an optical element 11, a photosensitive element 12, and a circuit module 13.

Referring to FIG. 3, in some embodiments, the optoelectronic sensing system 10 is deployed with an optoelectronic neural network model 20, and the optoelectronic neural network model 20 includes a feature screening module 21 and a feature processing module 22.

The optoelectronic neural network model 20 is a model combining an optical neural network and a conventional neural network. The feature screening module 21 corresponds to the optical neural network and is implemented by the optical element 11. The feature processing module 22 corresponds to the conventional neural network and may be deployed in the circuit module 13 of the optoelectronic sensing system 10 (such as a processor and a memory of the electronic device, and a processor and a memory of the server).

Optionally, the processor may include at least one of a Central Processing Unit (CPU) or a Graphics Processing Unit (GPU).

The CPU excels at complex logic control. For example, in an initialization phase of the neural network, the CPU is responsible for handling various complex setting and configuration tasks, such as loading a model parameter, setting a network architecture, and managing data reading and a preprocessing process.

The GPU excels at large-scale parallel computing. Therefore, an inference portion of the feature processing module 22 can be deployed on the GPU. In the neural network, both the training and inference processes involve a large number of matrix operations and vector computations, such as weight computation between the neurons and application of the activation function. The GPU may perform computation on a plurality of data points simultaneously, which greatly improves computing efficiency.

Optionally, the feature screening module 21 may be implemented based on the Deep Neural Network (DNN), and the feature processing module 22 may be implemented based on a Feedforward Neural Network (FNN), a Convolutional Neural Network (CNN), a Recurrent Neural Network (RNN), a Long Short-Term Memory (LSTM) network, or the like. The network can be freely selected based on requirements of the sensing task, to improve sensing accuracy and efficiency of the optoelectronic sensing system 10.

For example, when the sensing task is an image classification task, the feature processing module 22 may be implemented based on a ResNet 18 model. While ensuring efficient feature extraction and classification performance, this network architecture has a concise model structure and a moderate parameter, which facilitates efficient deployment on an embedded chip.

In some embodiments, the optical element 11 is a device with a light field modulation capability. The optical element 11 and the photosensitive element 12 are sequentially arranged in an incident light path direction.

Optionally, the optical element 11 includes at least one of a diffractive optical element, a liquid-crystal diffractive optical element, a spatial light modulator, or a metasurface.

The Diffractive Optical Element (DOE) is an optical element that modulates the light based on a light wave diffraction principle. It implements the optical neural network mainly in the following ways.
(1) Light field modulation and information encoding: The diffractive optical element is capable of precisely modulating wavefront of the incident light, and encoding input information into different parameters of the light field, such as an amplitude, a phase, and polarization. In the optical neural network, input data (such as an image or a signal) may be converted into optical signals by devices such as an electrooptical modulator, and the light field is then modulated by the diffractive optical element to realize the information encoding. For example, a pixel value of an image is mapped to the amplitude of the light field, or more complex feature information is encoded through phase modulation. In this way, the light field carries information of the input data, which provides a basis for subsequent processing.
(2) Simulation of neuron computation: In the optical neural network, the diffractive optical element is capable of simulating a computing function of neurons. The core computation of the neurons is to perform the weighted summation on the input signals and perform the non-linear transformation through the activation function. the diffractive optical element can implement superposition and processing of the optical signals through the principles of light interference and diffraction, which is similar to the weighted summation process of the neurons. For example, a plurality of inputted optical signals converge at a certain position after passing through different diffraction paths, and their light fields interfere with each other. The result of the process is equivalent to performing the weighted summation on the input signals. Meanwhile, by selecting an appropriate material or structure, the diffractive optical element can also introduce a non-linear effect to simulate the activation function of neurons, thereby realizing a more complex computing function.
(3) Construction of a network connection: The diffractive optical element is capable of constructing connections between layers in the optical neural network. In the traditional electronic neural network, information is transmitted between the neurons through a weighted connection. In the optical neural network, the diffractive optical element can guide a propagation path of the optical signals to implement transmission and connection of optical signals between different layers. For example, by designing a pattern and structure of the diffractive optical element, the optical signals can be accurately propagated from a layer to a specific position of the next layer, forming an optical path similar to a connection of the neural network. Such the optical connection features high-speed parallelism, and can process a plurality of optical signals simultaneously, which greatly improves the computing efficiency.

The liquid-crystal diffractive optical element is a diffractive optical element based on a liquid crystal material, and utilizes characteristics of a liquid crystal such as optical anisotropy and an electrooptical effect to implement the diffraction and modulation of light. Functions implemented by the liquid-crystal diffractive optical element in the optical neural network are basically similar to those of the diffractive optical element, which is omitted herein.

The spatial light modulator is an optical device capable of modulating spatial distribution of light waves. It implements the optical neural network mainly in the following ways.
(1) Input data encoding: In the optical neural network, the input data (such as an image or a signal) needs to be converted into the optical signals for processing. The spatial light modulator can load input data in the form of electrical signals into the light field, modulates the amplitude, phase, polarization, and other characteristics of the light, and thus encode the input information into the optical signals. For example, for an image, a pixel value of the image may be converted into a change in a light intensity or phase of the corresponding pixel on the spatial light modulator, which allows the light field to carry information of the image, providing an input basis for subsequent neural network processing.
(2) Simulation of the neuron operation: The neuron computation in the optical neural network mainly includes the weighted summation of the input signals and a non-linear activation operation. The spatial light modulator can implement superposition of the plurality of inputted optical signals to simulate the weighted summation process of neurons based on the principles of light interference and diffraction. Specifically, different inputted optical signals pass through different pixel regions on the spatial light modulator, and each pixel region modulates the optical signals based on a predetermined weight. Then, these modulated optical signals propagate in space and interfere and superimpose with each other, and the obtained result is similar to the weighted summation of the input signals by neurons. In addition, by selecting an appropriate material or combining with other optical elements, the spatial light modulator can also introduce the non-linear effect to realize the activation function of the neurons. For example, the liquid crystal spatial light modulator is used to combine with a non-linear optical medium to perform the non-linear transformation on the optical signals.
(3) Construction of the network connection: The spatial light modulator can construct connection relationships between layers in the optical neural network. In the optical neural network, the optical signals need to be transmitted and processed between different layers. By modulating the light field, the spatial light modulator can guide the optical signals to accurately propagate from one layer to a specific position of the next layer, forming an optical path similar to a neural network connection. For example, by programmatically controlling a pixel pattern on the spatial light modulator, the optical signals can be propagated in a predetermined path to realize the connection between the layers. Moreover, the connection weight can be flexibly adjusted to adapt to different computing tasks and network architectures.

The metasurface is a two-dimensional planar structure composed of artificial microstructures at a subwavelength scale, which can flexibly modulate the phase, amplitude, polarization, and other characteristics of the light. A specific phase distribution can be realized by designing a geometric shape, size, and arrangement manner of the microstructures on the metasurface. It implements the optical neural network mainly in the following ways.
(1) Light field modulation and information encoding: The metasurface is capable of implementing flexible and precise modulation of the amplitude, phase, polarization, and other characteristics of the light, which is the basis for constructing the optical neural network. In the optical neural network, the input information (such as an image or data) can be encoded into different characteristics of the light field. For example, by designing the microstructures of the metasurface, the microstructures at different positions produce different delays to the phase of incident light, thereby mapping features of the input data to the phase distribution of the light. In this way, the light field carries the input information, which provides an information carrier for subsequent processing. For image input, pixel information of the image can be encoded into the change of the amplitude or phase of the light, so that the metasurface can process the image information.
(2) Simulation of neuron computation: The neuron computation in the optical neural network includes operations such as the weighted summation and the non-linear transformation of the input signals. The metasurface may simulate these operations through the principles of light interference and scattering. The plurality of inputted optical signals pass through different microstructure regions on the metasurface, and each microstructure region modulates the optical signal based on its design characteristics, which is equivalent to weighting the input signals. Then, these modulated optical signals interfere and superimpose with each other in space, realizing a process similar to the weighted summation of neurons. In addition, by rationally designing the material and structure of the metasurface to introduce the non-linear optical effect, such as second harmonic generation and optical limiting, or by combining with a non-linear optical material, a non-linear activation function of the neurons can be realized, thereby completing a more complex computing task.
(3) Construction of the network connection: The metasurface may construct the connection relationships between the layers in the optical neural network. In a traditional neural network, information is transmitted between the neurons through the weighted connection. In a metasurface-based optical neural network, a microstructure layout of the metasurface and a propagation path of the light may be designed in a manner analogous to a connection of the neural network. For example, metasurfaces of different layers may be designed with a specific optical path, so that the optical signals are accurately propagated from one layer of metasurface to a specific position of the next layer of metasurface, forming the connection between the layers. By adjusting a microstructure parameter of the metasurface, a propagation and interaction mode of the optical signals can be changed, and then the connection weight of the network can be adjusted to adapt to different computing tasks and network architectures.

In this way, a function of the feature screening module 21 of the optoelectronic neural network model 20 of the present disclosure can be implemented through the optical element 11.

Optionally, the number of the optical element 11 is one or more. The one or more optical elements 11 are sequentially arranged in an incident light path direction of the optoelectronic sensing system 10.

It can be understood that, as an example, the feature screening module 21 is taken as the DNN. One or more optical elements 11 need to be correspondingly provided based on the number of network layers in the feature screening module 21.

Optionally, the feature screening module 21 includes a phase mask unit, and an optical parameter of the optical element 11 is determined based on a parameter of the phase mask unit.

A phase mask is an optical element capable of modulating the phase of the light. A parameter of a traditional phase mask is fixed, while the phase mask unit may be a learnable phase mask. Unlike the traditional phase mask, a parameter of the learnable phase mask may be optimized and adjusted through a specific learning algorithm.

During a training and learning process, the phase mask can adaptively change its modulation mode for the light field based on different input light fields and expected output targets, to realize more flexible, efficient and precise light field modulation.

For example, the spatial light modulator (SLM) is a device capable of dynamically controlling the light field, which can change its phase modulation characteristics for light through the electrical signal or optical signal. By using the SLM as the phase mask unit, a phase value of each pixel of the SLM is controlled by a computer, and these phase values are adjusted in real time based on an optimization algorithm during the training process, thereby realizing dynamic modulation and parameter learning of the light field.

It can be understood that, during training of the optoelectronic neural network model 20, in order to reduce a training cost, the learnable phase mask may be used to simulate the optical element 11. In this way, there is no need to re-fabricate the corresponding physical optical element 11 every time an adjustment is required during the training process.

Moreover, the learnable phase mask unit may be simulated by the computer, which can further reduce the model training cost. In this way, the entire training process of the optoelectronic neural network model 20 can be implemented through the computer. After the training is completed, the corresponding optical element 11 can be fabricated based on the parameter of the phase mask unit.

Optionally, the number of the phase mask unit is one or more. The one or more optical elements 11 are in one-to-one correspondence with the one or more phase mask units, and for each of the one or more optical element 11, phases at respective positions of the optical elements 11 are determined based on parameters at respective positions of a phase mask unit among the one or more phase mask units that corresponds to the optical element.

The setting of basic parameters of the feature screening module 21, such as the number (corresponding to the number of network layers of the feature screening module 21) and size (corresponding to the number of neurons in each network layer) of phase mask units in the feature screening module 21, may vary depending on different sensing tasks implemented by the optoelectronic neural network model 20. After the training of the optoelectronic neural network model 20 is completed, the optical element 11 corresponding to each phase mask unit can be fabricated based on the number and size of phase mask units in the feature screening module 21.

For example, as an example, the optical element 11 is taken as the diffractive optical element. Phases at different positions of the diffractive optical element can be respectively determined based on the phases at corresponding different positions of the corresponding phase mask unit.

The diffractive optical element is an optical element 11 which has specific microstructures, such as a relief structure and a step structure, fabricated on its surface, so that the light is diffracted during propagation, thereby realizing the modulation of characteristics of light such as phase and amplitude. The microstructures at different positions produce different diffraction effects on light, leading to different phases at different positions.

A binary optical element is taken as an example. The binary optical element is a common diffractive optical element, and its surface microstructure is usually composed of a plurality of binary steps. When the binary optical element is fabricated, phase modulation of light can be realized by precisely controlling parameters such as a height and width of each step. A height difference of each step determines an amount of phase change of the light when it passes through the step. Moreover, different phases can be achieved at different positions by rationally designing the height differences between the steps at different positions.

For another example, as an example, the optical element 11 is the metasurface. Phases at different positions of the metasurface can be determined based on the phases at different positions of the corresponding phase mask unit, respectively.

The metasurface is a two-dimensional planar structure composed of artificial structural units (i.e., meta-atoms) at the subwavelength scale. Each meta-atom can independently modulate characteristics of incident light such as phase, amplitude, and polarization. Therefore, by elaborately designing a shape, size, orientation, and arrangement of the meta-atoms, different phase delays can be achieved at different positions of the metasurface, thereby enabling arbitrary modulation of the wavefront.

Optionally, the optical element 11 is configured to perform dimensionality expansion or dimensionality reduction on an inputted optical signal.

Depending on a difference between the sensing tasks of the optoelectronic neural network model 20, the feature screening module 21 may need to perform the dimensionality expansion or dimensionality reduction on the input information. Dimensionality expansion can provide richer information to improve a sensing range or accuracy. Dimensionality reduction enables screening and processing of information, to reduce an amount of data processing and storage cost that are required to implement the sensing task, and improve the sensing accuracy.

For example, due to the limitation of the field of view of a camera, during gesture recognition, when a hand is outside the field of view, it cannot be sensed. Therefore, the optical element 11 may perform the dimensionality expansion on the input information to obtain information of a wider field of view, thereby increasing a range of gesture sensing.

For another example, during the gesture sensing, except for the hand, a large amount of redundant information exists in the scene. Therefore, information dimensionality reduction is required in this case to retain information related to a gesture as much as possible, which can reduce an amount of data processing and storage cost for subsequent gesture recognition, and also improve accuracy of gesture recognition.

In addition, after the optical element 11 performs the dimensionality reduction on the inputted optical signal, an amount of information that needs to be collected by the photosensitive element 12 is reduced accordingly, and a requirement for resolution of the photosensitive element 12 is greatly reduced. Therefore, a photosensitive element 12 with smaller resolution can be used, which can reduce the cost of the optoelectronic sensing system 10, and also lower power consumption of the low-resolution photosensitive element 12.

Optionally, a wavelength of the inputted optical signal may be any wavelength. For example, the optical signal may be visible light, infrared rays, ultraviolet rays, other electromagnetic waves in a THz band (such as an electromagnetic wave with a frequency of 1 terahertz (1,000,000,000,000 Hz), or the like, which is not limited herein.

In some embodiments, the photosensitive element 12 receives an optical signal passing through the optical element 11 to output an image signal.

The photosensitive element 12 is an electronic device that converts the optical signal into the electrical signal, and is widely used in various optical imaging devices, such as a digital camera, a video camera, and a mobile phone camera.

A core working principle of the photosensitive element 12 is based on a photoelectric effect. When the light irradiates the photosensitive element 12, photons hit atoms in a photosensitive material, so that electrons in the atoms obtain sufficient energy to escape, thereby generating electron-hole pairs. These electrons and holes are separated and collected under the action of an electric field inside the photosensitive element 12 to form a current or voltage signal. The current or voltage signal is processed and amplified by a subsequent circuit, and finally converted into a digital signal for recording and processing the image information.

Optionally, the number of photosensitive units of the photosensitive element 12 is less than or greater than the number of microstructures of the optical element 11.

That is, the resolution of the photosensitive element 12 may be less than or greater than resolution of the optical element 11. When the optical element 11 is used for dimensionality expansion, the amount of information that needs to be collected by the photosensitive element 12 increases accordingly. Therefore, the resolution of the photosensitive element 12 needs to be set to be greater than the resolution of the optical element 11. When the optical element 11 is used for dimensionality reduction, the amount of information that needs to be collected by the photosensitive element 12 is reduced accordingly. Therefore, the resolution of the photosensitive element 12 can be set to be less than the resolution of the optical element 11.

Optionally, the photosensitive element 12 includes a Charge-Coupled Device (CCD) or a Complementary Metal-Oxide Semiconductor (CMOS).

Optionally, a size of the photosensitive element 12 is m*n. Both m and n are greater than or equal to 50. For example, the size of the photosensitive element 12 may be 50*50, 66*66, 80*80, 100*100, 112*112, 150*150, 200*200, or 224*224.

In this way, the size of the photosensitive element 12 is relatively small, which can reduce the cost of the optoelectronic sensing system 10, and also lower the power consumption of the low-resolution photosensitive element 12.

Optionally, the optoelectronic sensing system 10 further includes a lens assembly 14. The lens assembly 14, the optical element 11, and the photosensitive element 12 are sequentially arranged in an incident light path direction of the optoelectronic sensing system 10.

It can be understood that a camera is generally provided with the lens assembly 14, which is composed of a lens mount and a lens group, to achieve focusing, depth of field adjustment, light intake adjustment, and the like for a shooting scene. In this way, it is beneficial to obtaining an image with better imaging quality.

After light is adjusted by the lens assembly 14, an optical signal with good imaging quality is obtained. The light signal then passes through the optical element 11 for feature screening or processing, to obtain an optical signal that meets the requirements of the sensing task of the optoelectronic sensing system 10. Thereafter, the photosensitive element 12 collects the optical signal to generate an image signal for processing by the feature processing module 22, to output final sensing information, which is beneficial to an improvement in the sensing accuracy.

Based on the introduction of the above content, the embodiments of the present disclosure provide a sensing method applied to the optoelectronic sensing system according to any of the above embodiments. The sensing method is described in detail below.

Referring to FIG. 4, a sensing method provided by the embodiments of the present disclosure is implemented by operations at steps 011 and 012, which are specifically described below.

At step 011, the image signal outputted by the photosensitive element is obtained.

At step 012, the image signal is processed through the feature processing module to output sensing information.

Specifically, when the optoelectronic sensing system executes the sensing task, an image of the scene is first collected. During the image collection, light in the scene passes through the optical element for processing to achieve the dimensionality expansion or dimensionality reduction. The optical signal after the dimensionality expansion or dimensionality reduction is collected by the photosensitive element, and then the image signal is generated through photoelectric induction.

The image signal is an electrical signal, and may be transmitted to the circuit module of the optoelectronic sensing system. The circuit module is deployed with the feature processing module of the optoelectronic neural network. Specifically, the feature processing module may be deployed in a memory and processor of the optoelectronic sensing system. The memory is used to store a parameter, weight, input data, and an intermediate computation result of the model. The processor is responsible for executing a computation task of the model, such as matrix multiplication and convolution.

After the processor receives the image signal, the processor may run the feature processing module to process the image signal, and finally output the sensing information corresponding to the sensing task.

In an example, the processor includes a CPU and a GPU. The CPU may preprocess the image signal (such as data loading, format conversion, or normalization), and then transmit the preprocessed data to the GPU for inference (such as performing computing-intensive operations, including matrix multiplication and convolution). The GPU transmits the inference result back to the CPU for post-processing (such as filtering and formatting the inference result), to finally output the sensing information. In this way, advantages of the CPU and GPU can be fully utilized to improve sensing efficiency of the optoelectronic sensing system.

For example, when the sensing task is the object recognition (taking face recognition as an example), the sensing information is face information. For another example, when the sensing task is the gesture recognition, the sensing information is gesture information. For another example, when the sensing task is the scene recognition, the sensing information is scene information.

With the sensing method of the present disclosure, the incident light field is adjusted through the optical element, which can perform convolution operation on the input feature similar to that in the conventional neural network, thereby implementing the function of the feature screening module in the optoelectronic neural network model. After the incident light is modulated by the optical element, emergent light propagating to the photosensitive element no longer carries unprocessed raw information of the current scene. Since the information processing occurs at a physical level, privacy leakage information in the current scene is avoided.

Subsequently, the photosensitive element can collect the emergent light to output the image signal, and transmit the image signal to the feature processing module. The feature processing module may process the image signal to achieve the sensing of scene targets, such as object recognition, gesture recognition, or scene recognition.

Moreover, compared with the implementation of information processing through the feature screening module, which consumes a large amount of computing resources, implementing the same information processing process through the optical element d consumes no computing resources, thus reducing the computing resource consumption of the optoelectronic neural network model during sensing.

In addition, since the modulation by the optical element is performed at the speed of light, implementing the function of the feature screening module through the optical element can also improve sensing efficiency of the optoelectronic neural network model.

In some embodiments, referring to FIG. 5, the operation at step 012 includes operations at steps 0121 and 0122.

At step 0121, lensless imaging is performed based on the image signal to generate a target image.

At step 0122, the target image is processed to obtain the sensing information.

Specifically, when no lens assembly is provided in the optoelectronic sensing system, a clear image cannot be obtained by the photosensitive element alone. Therefore, it is necessary to use a lensless imaging technology to process the image signal, to generate a target image that can be used for subsequent sensing.

The lensless imaging technology is an imaging method that does not rely on a traditional optical lens, which implements image capture and reconstruction mainly through computing and sensor technologies. Its core principle is to use a light field sensor to record a direction and intensity of the light, and then reconstruct an image from the captured light field data through an algorithm.

For example, the lensless imaging technology includes light field imaging, compressed sensing, or diffractive imaging.

For another example, the lensless imaging can be implemented by the feature processing module through neural network training.

In this way, by using the lensless imaging technology, the lens assembly is omitted, which further reduces a volume and cost of the optoelectronic sensing system.

The embodiments of the present disclosure further provide a construction method for an optoelectronic sensing system. The construction method is described in detail below.

Referring to FIG. 6, the construction method provided according to the embodiments of the present disclosure is implemented by the operations at steps 021 to 023, which are specifically described below.

At step 021, an optoelectronic neural network model is constructed. The optoelectronic neural network model includes a feature screening module and a feature processing module.

At step 022, an optical element of the optoelectronic sensing system is constructed based on a parameter of the feature screening module.

At step 023, the feature processing module is deployed in a circuit module of the optoelectronic sensing system.

Specifically, in the optoelectronic sensing system, the optical element needs to be fabricated based on the parameter of the feature screening module of the optoelectronic neural network model. Therefore, when the optoelectronic sensing system is constructed, the optoelectronic neural network model needs to be constructed first.

Optionally, referring to FIG. 7, the process of constructing the optoelectronic neural network model (i.e., the operation at step 021) includes the following operations at steps 0211 and 0212.

At step 0211, the feature screening module is constructed based on a predetermined all-optical diffractive network model. The all-optical diffractive model is used to simulate a process in which an incident light field is modulated by the optical element and the modulated incident light field propagates to the photosensitive element.

At step 0212, joint training is performed on the feature screening module and the feature processing module to construct the optoelectronic neural network model trained to convergence.

The All-Optical Diffractive Neural Network is a new type of computational model that combines an optical diffraction principle with the neural network. The all-optical diffractive network model can simulate the whole process of the incident light field being modulated by the optical element and then propagating to the photosensitive element based on a basic model corresponding to the feature screening module (such as a DNN).

That is, phase mask simulation can be performed based on the all-optical diffractive network model, thereby reducing the training cost and enabling the training of the optoelectronic neural network model to be fully implemented online.

Optionally, referring to FIG. 8, the construction process of the feature screening module (i.e., the operation at step 0211) includes the following operations at steps 02111 to 02113.

At step 02111, a phase mask unit simulating the optical element is defined.

At step 02112, an input light field of the phase mask unit is processed by using a predetermined Fresnel diffractive model to determine an output light field.

At step 02113, resampling processing is performed on the output light field. The resampled output light field matches resolution of the photosensitive element.

The Fresnel diffractive model is a theoretical model describing a diffraction phenomenon of light in a near-field region. Its theoretical basis is a Huygens-Fresnel principle and a superposition principle.

Huygens-Fresnel principle: Each point on a wavefront may be regarded as a new source of secondary spherical waves, and light disturbance at any point in space is coherent superposition of all secondary wavelets propagating to that point.

Superposition principle: During the propagation of light waves, the vibration at the point where multiple waves meet is a vector sum of vibrations generated by each wave individually at that point.

The Fresnel diffractive model is used to simulate a propagation process of an incident light field from the optical element to the photosensitive element.

Specifically, when the feature screening module is constructed, one or more phase mask units may be defined. The one or more phase mask units are used to simulate the optical elements. Then, a relationship between the input light field and the output light field is established based on the Fresnel diffractive model. The output light field is the light field that passes through the phase mask units and then propagates to the photosensitive element.

As an example, the optoelectronic neural network model is trained online. Since there is no actual photosensitive element, it is necessary to perform resampling processing on the output light field based on predetermined resolution of the photosensitive element, so that the output light field matches the predetermined resolution of the photosensitive element, thereby achieving simulation of sampling by the photosensitive element.

In this way, the whole process of the feature screening module (processing of the input light field, propagation, obtaining of the output light field, and output of the image signal by the photosensitive element) can be simulated, which ensures accuracy of the online training of the optoelectronic neural network model.

After the simulation of the feature screening module is achieved, the joint training can be performed on the feature screening module and the feature processing module to obtain the optoelectronic neural network model trained to convergence.

After the optoelectronic neural network model trained to convergence is obtained, the corresponding optical element in the optoelectronic sensing system can be constructed based on the parameter of the feature screening module.

When the optical elements are fabricated, the corresponding optical elements can be fabricated respectively based on the parameters of the phase mask units in the feature screening module, so that the optical elements can implement the function of the feature screening module.

After the optical elements are fabricated, the optical elements can be installed based on a spacing between the phase mask units and a spacing between the phase mask units and the photosensitive element.

Finally, the trained feature processing module can be deployed to the circuit module of the optoelectronic sensing system, thereby completing the construction of the entire optoelectronic sensing system.

In some embodiments, referring again to FIG. 8, the operations at step 0212 includes operations at steps 02121 to 02124.

At step 02121, a model parameter of the feature screening module is set. The model parameter includes at least one of: the number of the phase mask unit, the size of the phase mask unit, or the resolution of the photosensitive element.

At step 02122, the joint training is performed, with different model parameters, on the feature screening module and the feature processing module based on a predetermined training set to construct intermediate neural network models trained to convergence corresponding to the different model parameters.

At step 02123, prediction accuracy rates of the intermediate neural network models are tested based on a predetermined test set.

At step 02124, the optoelectronic neural network model is determined based on the prediction accuracy rates of the intermediate neural network models, and based on the resolution of the photosensitive element and the number and size of phase mask unit corresponding to each of the intermediate neural network models.

Specifically, when the feature screening module is constructed, different settings of the model parameters of the feature screening module may also affect a final sensing effect of the model.

Therefore, during training, a corresponding intermediate neural network model is obtained through training with each of the different model parameters, respectively. Then, an optimal intermediate neural network model is selected as a final optoelectronic neural network model based on actual needs of the user.

The specific process is as follows.

Firstly, the model parameter of the feature screening module, such as the number and size of the phase mask unit, and the resolution of the photosensitive element are set.

Then, based on the set model parameter, the predetermined training set is inputted to perform the joint training on the feature screening module and the feature processing module, to obtain the intermediate neural network model that is trained to convergence and corresponds to the model parameter.

Thereafter, the model parameter of the feature screening module is reset to be different from that of the trained model, and training is re-performed to obtain another intermediate neural network model. By repeating this process, intermediate neural network models respectively corresponding to different model parameters can be obtained.

Subsequently, the prediction accuracy rates of different intermediate neural network models are tested based on the predetermined test set, to obtain the prediction accuracy rates of the intermediate neural network models as a reference factor for subsequent selection of the optimal model.

Finally, the requirements of the optoelectronic sensing system for mounting space, cost, and prediction accuracy rate are comprehensively considered, to select the optimal intermediate neural network model (such as the one that meets the above requirements) from the intermediate neural network models as the final optoelectronic neural network model.

For example, when the requirement for prediction accuracy rate has the highest priority, among the intermediate neural network models, an intermediate neural network model for which the number of layers and size of phase mask unit satisfy a size constraint condition of the optoelectronic sensing system and with the highest prediction accuracy rate can be determined as the optoelectronic neural network model.

Alternatively, when the cost requirement has the highest priority, among the intermediate neural network models, an intermediate neural network model for which the number of layers and size of phase mask unit satisfy the size constraint condition of the optoelectronic sensing system and the prediction accuracy rate is greater than a predetermined accuracy rate, and with the lowest resolution can be determined as the optoelectronic neural network model.

Alternatively, when the requirement for mounting space has the highest priority, among the intermediate neural network models, an intermediate neural network model for which the prediction accuracy rate is greater than the predetermined accuracy rate, the resolution is smaller than predetermined resolution, and a mounting space corresponding to the phase mask unit is the smallest can be determined as the optoelectronic neural network model. The mounting space corresponding to the phase mask unit is determined based on the number of layers and size of phase mask unit.

In this way, by training the intermediate neural network models corresponding to the different model parameters, an optimal model that meets different needs of the user can be obtained, which is beneficial to an improvement in competitiveness of the optoelectronic sensing system.

In order to facilitate the understanding of the construction method and sensing method of the present disclosure, a specific example is described below, where the sensing task is image classification, and the construction process is divided into two parts: system construction and application.

### 1. Construction of the optoelectronic sensing system

### 1. Data preparation and online preprocessing

Training set construction: A dataset containing more than 3000 JPEG-format images is collected and constructed, and a correspondence between the images and category labels is established.

### 2. Online data augmentation

Data augmentation operations, such as random cropping, horizontal flipping, color jitter, and rotation, are performed in real time during data loading.

### 3. Construction of the overall architecture of the optoelectronic neural network model

Feature screening module (corresponding to the DOE module):

The DOE is physically modeled using the all-optical diffractive network model. This module adopts a learnable phase mask (i.e., phase mask unit) to modulate the incident light field, and simulates light field propagation from the DOE to the sensor (i.e., a photosensitive element, with a propagation distance such as a predetermined distance) through the Fresnel diffractive model.

In this module, physical parameters such as a total size of the DOE, a pixel size, and the number of layers of the DOE are incorporated into a network design to realize end-to-end optical simulation.

Back-end classification network (corresponding to the feature processing module):

A pre-trained deep convolutional neural network, such as a lightweight ResNet18 model, is adopted for the back end, with the last layer replaced by a fully connected layer adapted to the actual number of categories to achieve image classification.

This network architecture ensures efficient feature extraction and classification performance while maintaining a simple model structure and a moderate parameter, which is convenient for efficient deployment on an embedded chip.

It should be noted that, in order to match a sampling requirement of the sensor, an output light field from the feature screening module to the sensor needs to be resampled, converted into an image consistent with resolution of the sensor, and then inputted into a back-end classification module.

### 4. End-to-end joint training

Joint optimization objective:

The feature screening module and the back-end classification module are connected in series to form an overall system. A phase parameter of the phase mask and a weight of the back-end network are optimized simultaneously through end-to-end training.

Training process:

The data augmentation is dynamically performed on each mini-batch of data during online loading. Then, forward propagation is performed sequentially through the feature screening module (including phase modulation and Fresnel diffraction propagation) and the back-end classification network.

A classification loss (such as cross-entropy loss) is used to update the parameters of the feature screening module and the back-end classification network through backpropagation. Finally, an optimal optical modulation scheme and an optimal classification network parameter are obtained, i.e., the optoelectronic neural network model trained to convergence is obtained.

### 5. Training results and parameter output

After the joint training, two key parameter sets are obtained.

DOE parameter: The model parameters set before the model training (such as the number and size of the phase mask unit, and the resolution of the photosensitive element), and the trained parameters obtained through training (such as the phases at respective positions of the phase mask), are used for fabrication of an actual optical element.

Classification network parameter: The trained weight of the back-end classification network is deployed on the chip (such as the processor and memory of the optoelectronic sensing system) for real-time image classification.

### 2. Model application

### 1. Product fabrication and deployment

Based on the DOE parameter obtained from training, an actual optical element is fabricated using an optical manufacturing technology (such as 3D printing or photolithography). The trained classification network parameter is programmed into the chip.

### 2. Real-time optical collection and preprocessing

After the incident light is modulated by the optical element, an image with a specific diffractive light field is formed, and then sampled with high precision through the sensor. After the preprocessing (such as normalization and resampling), the collected image is directly used as an input of the back-end classification network.

### 3. On-chip classification and feedback output

The back-end classification network (lightweight ResNet18) deployed on the chip performs fast classification on the real-time collected image and outputs a classification result. The classification result is used for real-time control, monitoring or decision feedback to realize automated application.

In the embodiments of the present disclosure, the term “module (such as the feature processing module)” or “unit” may refer to a computer program or a portion of a computer program with a predetermined function, which works with other relevant parts to achieve a predetermined objective, and may be fully or partially implemented by software, hardware (such as a processing circuit or a memory), or a combination thereof. Similarly, one or more processors (or a plurality of processors or memories) may be used to implement one or more modules or units. In addition, each module or unit may be part of an overall module or unit that encompasses the functionality of the module or unit.

In some embodiments, referring to FIG. 9, FIG. 9 is a schematic structural diagram of an optoelectronic sensing system provided according to an embodiment of the present disclosure. The optoelectronic sensing system 500 includes a processor 501 and a memory 502. The memory 502 stores a computer program 503 executable on the processor 501. The program 503 is configured to implement, when executed by a processor 501, the various processes of the embodiments of the sensing method described above, and can achieve the same technical effect. Details thereof are omitted herein to avoid redundancy.

The embodiments of the present disclosure further provide a non-transitory computer-readable storage medium. The non-transitory computer-readable storage medium has a computer program stored thereon. The computer program is configured to implement, when executed by a processor, the various processes of the embodiments of the sensing method or the construction method described above, and can achieve the same technical effect. Details thereof are omitted herein to avoid redundancy.

The processor is the processor in the electronic device and/or server described in the above embodiments. The computer-readable storage medium may be a computer read-only memory (ROM), a random access memory (RAM), a magnetic disk, or an optical disk.

The computer-readable medium may include a computer storage medium and a communication medium. The computer storage medium includes volatile and non-volatile, removable and non-removable media implemented in any method or technology for storage of information such as a computer-readable instruction, a data structure, a program module, or other data. The computer storage medium includes a RAM, a ROM, an Erasable Programmable Read-Only Memory (EPROM), an Electrically Erasable Programmable Read-Only Memory (EEPROM), a flash memory or other solid-state memory technology, a CD-ROM, a Digital Versatile Disc (DVD) or other optical storage, a magnetic cassette, a magnetic tape, magnetic disk storage or other magnetic storage devices. Of course, those skilled in the art will appreciate that the computer storage medium is not limited to the above types.

The embodiments of the present disclosure further provide a computer program product, including a computer program. The computer program, when executed by a processor, implements the various processes of the embodiments of the sensing method or the construction method described above, and can achieve the same technical effect. Details thereof are omitted herein to avoid redundancy.

It can be understood that, in the specific embodiments of the present disclosure, data related to user identity or characteristics is involved. When the above embodiments of the present disclosure are applied to a specific product or technology, obtaining user permission or consent is required , and the collection, use and processing of relevant data need to comply with the relevant laws, regulations and standards of the relevant countries and regions.

In the description of this specification, descriptions with reference to the terms “some embodiments”, “in an example”, “exemplarily”, etc., mean that specific features, structure, materials, or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, those skilled in the art can combine the different embodiments or examples and the features of the different embodiments or examples described in this specification without contradicting each other.

Any process or method described in a flowchart or described herein in other ways may be understood to include one or more modules, segments, or portions of codes of executable instructions for achieving specific logical functions or steps in the process. The scope of a preferred embodiment of the present disclosure includes other implementations. A function may be performed not in a sequence shown or discussed, including a substantially simultaneous manner or a reverse sequence based on the function involved, which should be understood by those skilled in the art to which the embodiments of the present disclosure belong.

Although the embodiments of the present disclosure have been shown and described above, it can be understood by those skilled in the art that various changes, modifications, replacements, and variations can be made to these embodiments without departing from the principles and ideas of the present disclosure. The scope of the present disclosure is defined by the claims as attached and their equivalents.

What is claimed is:

1. A sensing method, applied to an optoelectronic sensing system deployed with an optoelectronic neural network model, wherein the optoelectronic neural network model comprises a feature screening module and a feature processing module; and wherein the optoelectronic sensing system comprises an optical element and a photosensitive element, the photosensitive element being configured to collect an optical signal passing through the optical element and output an image signal, and a parameter of the optical element being determined based on a parameter of the feature screening module, the method comprising:
obtaining the image signal outputted by the photosensitive element; and
processing the image signal through the feature processing module to output sensing information.

2. The sensing method according to claim 1, wherein the feature processing module is deployed in a circuit module of the optoelectronic sensing system, and the circuit module comprises a processor and a memory.

3. The sensing method according to claim 2, wherein the processor comprises at least one of a central processing unit or a graphics processing unit.

4. The sensing method according to claim 1, wherein the feature screening module comprises a phase mask unit, and an optical parameter of the optical element is determined based on a parameter of the phase mask unit.

5. The sensing method according to claim 4, wherein the number of the optical element is one or more, the one or more optical elements being sequentially arranged in an incident light path direction of the optoelectronic sensing system.

6. The sensing method according to claim 5, wherein the number of the phase mask unit is one or more, the one or more optical elements are in one-to-one correspondence with the one or more phase mask units, and for each of the one or more optical elements, phases at respective positions of the optical element are determined based on parameters at respective positions of a phase mask unit among the one or more phase mask units that corresponds to the optical element.

7. The sensing method according to claim 1, wherein the optical element is configured to perform dimensionality expansion or dimensionality reduction on an inputted optical signal.

8. The sensing method according to claim 1, wherein the optical element comprises at least one of a diffractive optical element, a liquid-crystal diffractive optical element, a spatial light modulator, or a metasurface.

9. The sensing method according to claim 1, wherein the number of photosensitive units of the photosensitive element is smaller than or greater than the number of microstructures of the optical element; and/or
wherein the photosensitive element comprises a charge-coupled device or a complementary metal-oxide semiconductor.

10. The sensing method according to claim 1, wherein the optoelectronic sensing system further comprises a lens assembly, wherein the lens assembly, the optical element, and the photosensitive element are sequentially arranged in an incident light path direction of the optoelectronic sensing system.

11. The sensing method according to claim 1, wherein said processing the image signal through the feature processing module to obtain an intermediate processing result comprises:
performing lensless imaging based on the image signal to generate a target image; and
processing the target image to obtain the sensing information.

12. The sensing method according to claim 1, wherein a size of the photosensitive element is m*n, wherein both m and n are greater than or equal to 50.

13. The sensing method according to claim 1, wherein the optoelectronic sensing system is constructed by:
constructing the optoelectronic neural network model;
constructing the optical element of the optoelectronic sensing system based on the parameter of the feature screening module; and
deploying the feature processing module in a circuit module of the optoelectronic sensing system.

14. The sensing method according to claim 13, wherein:
said constructing the optoelectronic neural network model comprises:
constructing the feature screening module based on a predetermined all-optical diffractive network model, wherein the all-optical diffractive network model is used to simulate a process in which an incident light field is modulated by the optical element and then propagates to the photosensitive element; and
performing joint training on the feature screening module and the feature processing module to construct the optoelectronic neural network model trained to convergence.

15. The sensing method according to claim 14, wherein said constructing the feature screening module based on the predetermined all-optical diffractive network model comprises:
defining a phase mask unit simulating the optical element;
processing an input light field of the phase mask unit by using a predetermined Fresnel diffractive model to determine an output light field; and
performing resampling processing on the output light field, wherein the resampled output light field matches resolution of the photosensitive element.

16. The sensing method according to claim 15, wherein said performing the joint training on the feature screening module and the feature processing module to construct the optoelectronic neural network model trained to convergence comprises:
setting a model parameter of the feature screening module, wherein the model parameter comprises at least one of: the number of the phase mask unit, a size of the phase mask unit, or the resolution of the photosensitive element;
performing, with different model parameters, the joint training on the feature screening module and the feature processing module based on a predetermined training set to construct intermediate neural network models that are trained to convergence and correspond to the different model parameters;
testing prediction accuracy rates of the intermediate neural network models based on a predetermined test set; and
determining the optoelectronic neural network model based on the prediction accuracy rates of the intermediate neural network models, and based on the resolution of the photosensitive element and the number and size of the phase mask unit corresponding to each of the intermediate neural network models.

17. The sensing method according to claim 16, wherein said determining the optoelectronic neural network model based on the prediction accuracy rates of the intermediate neural network models, and based on the resolution of the photosensitive element and the number and size of the phase mask unit corresponding to each of the intermediate neural network models comprises:
determining, among the intermediate neural network models, an intermediate neural network model for which the number and size of the phase mask unit satisfy a size constraint condition of the optoelectronic sensing system and with the highest prediction accuracy rate as the optoelectronic neural network model; or
determining, among the intermediate neural network models, an intermediate neural network model for which the number and size of the phase mask unit satisfy the size constraint condition of the optoelectronic sensing system and the prediction accuracy rate is greater than a predetermined accuracy rate, and with the lowest resolution as the optoelectronic neural network model; or
determining, among the intermediate neural network models, an intermediate neural network model for which the prediction accuracy rate is greater than the predetermined accuracy rate, the resolution is smaller than predetermined resolution, and a mounting space corresponding to the phase mask unit is the smallest as the optoelectronic neural network model, wherein the mounting space corresponding to the phase mask unit is determined based on the number and size of the phase mask unit.

18. The sensing method according to claim 15, wherein said constructing the optical element of the optoelectronic sensing system based on the parameter of the feature screening module comprises:
constructing the optical element based on a parameter of the phase mask unit.

19. An optoelectronic sensing system, comprising:
a memory;
a processor; and
a computer program stored in the memory and operable on the processor, wherein the processor, when executing the program, implements the sensing method according to claim 1.

20. An electronic device, comprising the optoelectronic sensing system according to claim 19.
